(19) United States
(12) Patent Application Publication
(10) Pub. No.: US 2005/0044246 A1
(43) Pub. Date: Feb. 24, 2005

(54) Data management server, data management method and computer program

(75) Inventors: Hiroyuki Kawabata, Kawanishi-shi (JP); Kazuo Inui, Itami-shi (JP); Hisashi Uchida, Kuse-gun (JP); Kiyoshi Emori, Takatsuki-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc., Chiyoda-ku (JP)

(21) Appl. No.: 10/811,858

(22) Filed: Mar. 30, 2004

(30) Foreign Application Priority Data
Aug. 6, 2003 (JP) 2003-288050

(51) Int. Cl. G06F 15/167; G06F 15/16; G06F 15/177

(52) U.S. Cl. 709/229; 709/215; 709/219; 709/217

(57) ABSTRACT

A data management server that, even in a client-server network environment, can prevent data stored in a user's folder on the server from being used by others when the user is not working. The data management server that manages data that can be used by multiple terminal devices, and constitutes a storage device in which separate storage areas are allocated for each user, a determination unit that determines which of the terminal devices is in a state in which it is able to access the data management server, and an access management unit that, when a terminal device issues a request to access a separate storage area of the storage device, if it is determined by the determination unit that the terminal device being used by a user associated with the separate storage area is in a state in which it can access the data management server, permits the terminal device that requested to access the data stored in the separate storage area, while if the terminal device is not in such a state, denies access to the data stored in the separate storage area.

This application is based on Japanese Patent Application No. 2003-288050 filed in Japan on Aug. 6, 2003, the entire content of which is hereby incorporated by reference.

### BACKGROUND OF THE INVENTION

1. Field of the Invention

The present invention relates to a technology to enable networked terminal devices to access a shared folder located on a computer such as a server.

2. Description of the Related Art

Technologies for sharing folders located on a computer on a network with multiple other computers have been proposed in the conventional art.

According to the system described in Japanese Laid-Open Patent Application No. 2003-15882, for example, each user, using a networked client computer, can access a shared folder on a server and run programs stored in this shared folder. This type of system is generally termed a ‘client-server network’. With a client-server network, if a shared folder is created for each user on the server, users can store their individual data on the server.

In Japanese Laid-Open Patent Application Nos. 2003-5937 and 2001-175387, a system is described whereby documents located on any of multiple networked devices can be shared by any such device. This type of system is generally called a ‘peer-to-peer network’.

In a peer-to-peer network, when a user's own terminal device is powered off, or when it is not connected to the network, the files stored on that terminal device cannot be used by other users. Therefore, the problem of other users accessing the user's own files on the user's terminal device without the user's knowledge while the user is not operating the terminal device rarely occurs.

However, a peer-to-peer network is not suitable for a large-scale network system. Furthermore, in order for a folder on a terminal device to be shared, the terminal device must be equipped with a server function. Therefore, such a network is not suitable for a small-scale terminal device such as a PDA (Personal Digital Assistant) or cellular telephone.

On the other hand, because all documents are centrally managed from the server in a client-server network, such a network is well suited for management of each user's shared folder in a large-scale system.

However, in a client-server network, a frequently occurring problem is that other users access the contents of the user's shared folder (data) without the user's knowledge regardless whether or not the user is operating the terminal device.

### OBJECTS AND SUMMARY

An object of the present invention is to provide an improved data management server, data management method and computer program that eliminate the problems described above.

Another object of the present invention is to provide a data management server, data management method and computer program that, even in a client-server network environment, can prevent data stored in a user's folder on the server from being used by others when the user is not working.

These and other objects are achieved by providing a data management server that manages data that can be used by multiple terminal devices and constituting:
a storage device in which separate storage areas are allocated for each user;
a determination unit that determines which of the terminal devices is in a state in which it is able to access the data management server; and
an access management unit that, when a terminal device issues a request to access a separate storage area of the storage device, if it is determined by the determination unit that the terminal device being used by a user associated with the separate storage area is in a state in which it can access the data management server, permits the terminal device that requested to access the data stored in the separate storage area, while if the terminal device is not in such a state, denies access to the data stored in the separate storage area.

The above data management server may further include an identification information notification unit that issues, to the terminal device that has requested access to the data management server, identification information that identifies separate storage areas regarding, from among all users to whom separate storage areas are allocated, only those users who are using a terminal device determined by the determination unit to be in a state in which it can access the data management server. It is furthermore acceptable if (i) the determination unit makes the above determination at prescribed intervals, (ii) the identification information notification unit determines, based on the results of the most recent determination described above, the users regarding whom the above identification information will be given, and the access management unit determines whether or not to permit access based on the results of the most recent determination described above.

In the above data management server, it is acceptable if the data constitutes an executable file, i.e., application software, that is executed on the data management server, and when a terminal device requests that this executable file be run, the access management unit permits the executable file to be run where it is determined by the determination unit that the terminal device being used by the user associated with the separate storage area in which the executable file is stored is in a state in which it can access the data management server, but does not permit the executable file to be run where it is determined that the terminal device is not in such a state.

These and other objects are also achieved by a data management method that manages a storage unit in which separate storage areas are allocated for each user, such method including the steps of:
when a request to access a separate storage area of the storage unit is received from a terminal device, determining whether or not the terminal device being used by the user associated with the separate storage area is in a state in which it can access the storage unit; and
when it is determined that the terminal device is in such the state in which it can access the storage unit, permitting the terminal device that requested to access the data stored in the separate storage area, but denying access when the terminal device is not in such a state.

These and other objects are also achieved by providing a computer program that is run on a computer having a storage unit in which separate storage areas are allocated to each user, such computer program executing on the computer the processes of:
determining terminal devices that are in a state in which they can access the computer; and
when a request to access a separate storage area of the storage unit is received from a terminal device, and it is determined that the terminal device being used by the user associated with the separate storage area is in a state in which it can access the computer, permitting the terminal device that requested to access the data stored in the separate storage area, but denying access where the terminal device is not in such a state.

According to the present invention, persons other than the user are prevented from using files stored in the user's folder when the user is not working, even in a client-server network environment, thereby improving security.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 shows an example of the construction of a file sharing system having a multifunction apparatus pertaining to the present invention;

FIG. 2 shows an example of the hardware construction of the multifunction apparatus;

FIG. 3 shows an example of the functional construction of the multifunction apparatus;

FIG. 4 shows an example of a terminal device information table;

FIG. 5 shows an example of a folder information table;

FIG. 6 shows an example of a list view screen;

FIG. 7 shows an example of a folder contents screen;

FIG. 8 is a flow chart that explains an example of the processing sequence by which it is determined whether or not the folder name of another user's folder will be displayed;

FIG. 9 is a flow chart that explains an example of the processing sequence by which it is determined whether or not the folder name of the user's own folder will be displayed; and

FIG. 10 is a flow chart that explains an example of the processing sequence pertaining to file management performed when a folder is accessed.

### DETAILED DESCRIPTION OF THE PREFERRED EMBODIMENTS

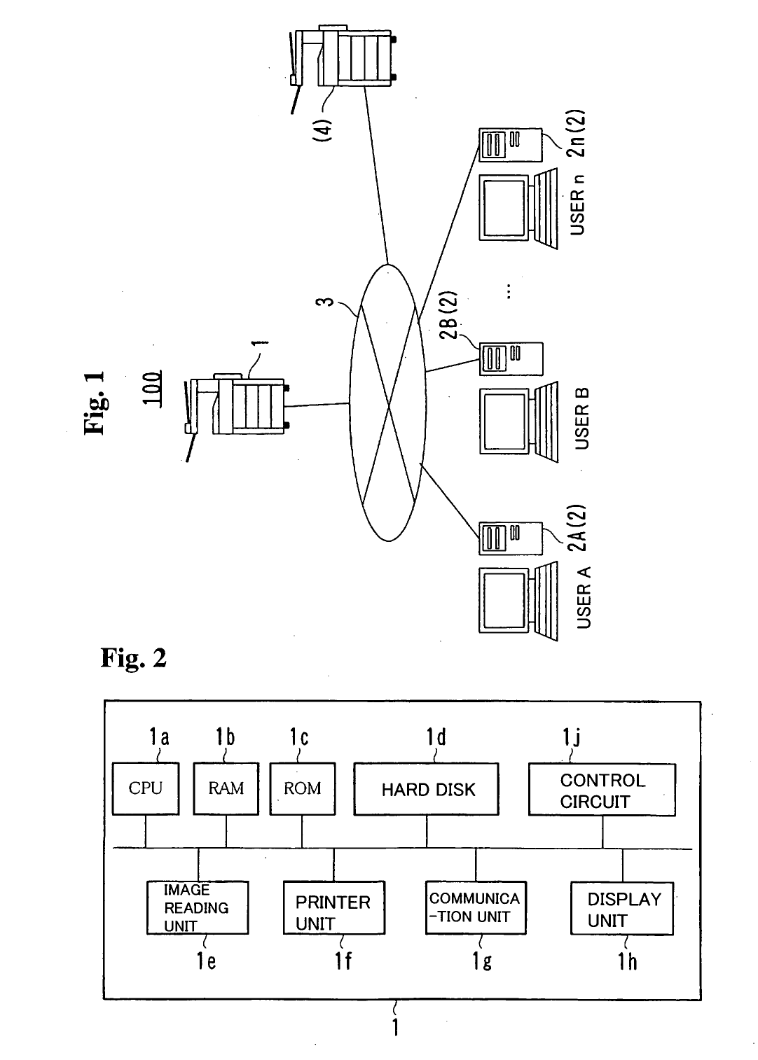

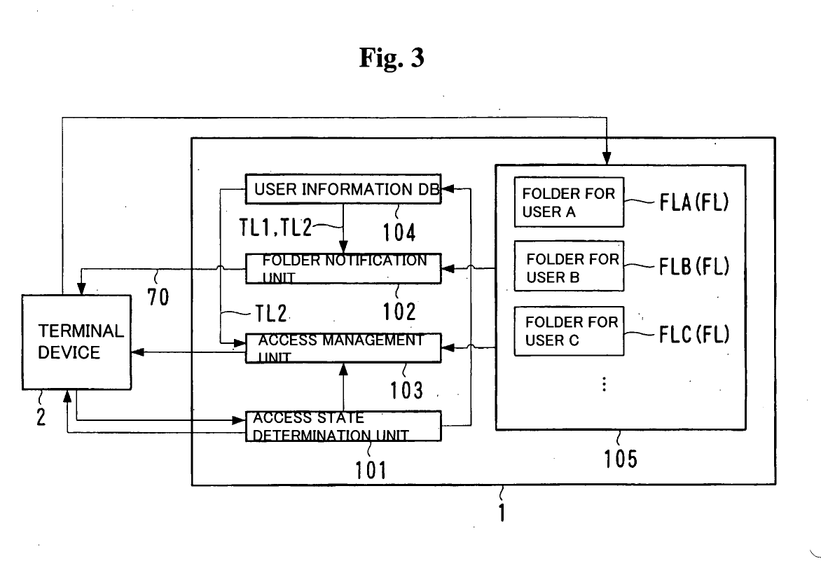

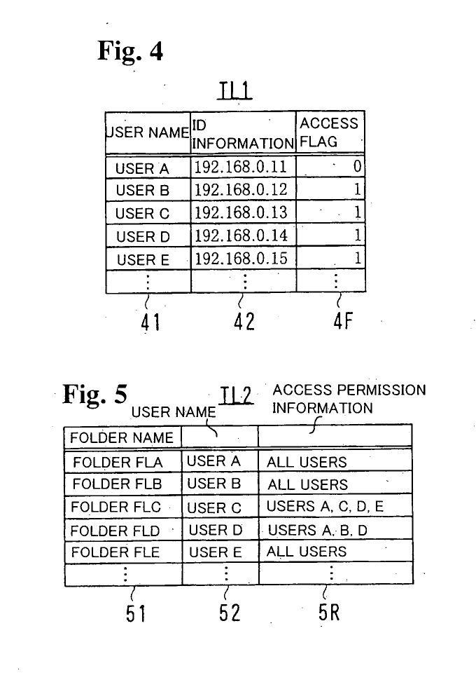

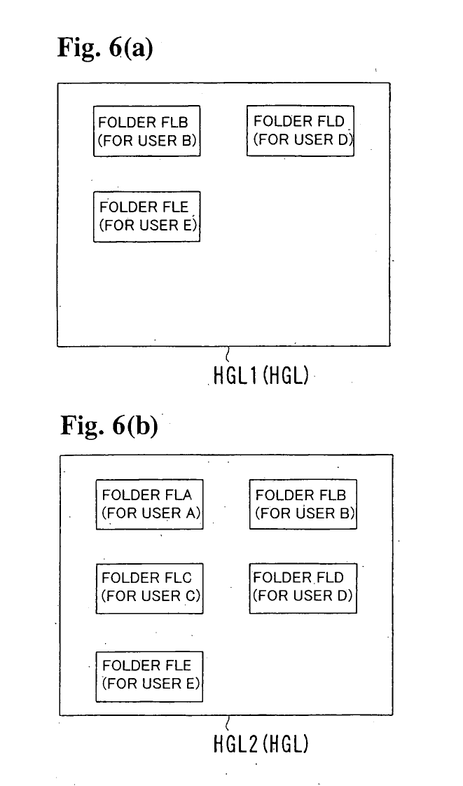

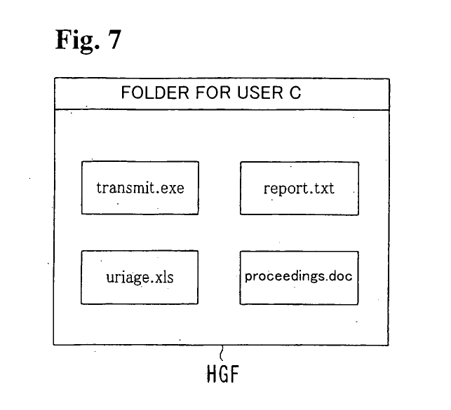

FIG. 1 shows an example of the construction of a file sharing system 100 having a multifunction apparatus 1 pertaining to the present invention, FIG. 2 shows an example of the hardware construction of the multifunction apparatus 1, FIG. 3 shows an example of the functional construction of the multifunction apparatus 1, FIG. 4 shows an example of a terminal device information table TL1, FIG. 5 shows an example of a folder information table TL2, FIG. 6 shows an example of a list view screen HGL, and FIG. 7 shows an example of a folder contents screen HGF.

As shown in FIG. 1, the file sharing system 100 is composed of a multifunction apparatus 1 that serves as the data management server pertaining to the present invention, multiple terminal devices 2A, 2B and so forth, and communication lines 3. The multifunction apparatus 1 and terminal devices 2 are interconnected over the communication lines 3, and a portion of the data managed by the multifunction apparatus 1 is shared among the multiple terminal devices 2. For the communication lines 3, the Internet, an intranet, public telephone lines or dedicated lines may be used. TCP/IP or FTP may be used as the communication protocol. Where the network of the file sharing system 100 is a LAN, NetBEUI or SMB (Server Message Block) may be used.

Each user is assigned a terminal device 2. The terminal device 2 may be a personal computer, workstation, PDA (Personal Digital Assistant) or cellular telephone.

The multifunction apparatus 1 is an apparatus that combines the functions of a copier, printer, scanner, facsimile machine and/or document server, for example, and may be referred to as an MFP (Multifunction Peripheral). This multifunction apparatus 1 is composed of a CPU 1a, RAM 1b, ROM 1c, hard disk 1d, image reading unit 1e, printer unit 1f, communication unit 1g, display unit 1h, control circuit 1j and the like, as shown in FIG. 2.

The control circuit 1j is a circuit that controls the image reading unit 1e, printer unit If, communication unit 1g and display unit 1h. Configuration values for these units are stored in the ROM 1c.

Stored on the hard disk 1d are an OS (operating system), an access state determination unit 101, a folder notification unit 102, an access management unit 103, programs and data used to implement the various functions of a user information database 104, and programs and data to create a user data storage area 105 on the hard disk 1d. All or part of these programs and data may alternatively be stored in the ROM 1c. Similarly, all or part of the functions shown in FIG. 3 may be implemented by processors (circuits).

The user data storage area 105 is a storage area that can be used by each user of a terminal device 2. Specifically, a folder (directory) FL is assigned for each user of a terminal device 2 as a separate storage area. Each user can store (save) his own data in his folder FL as files. A maximum amount for data that can be saved in each folder FL may be imposed. Multiple folders FL may be created and assigned for a given user. Access permission may be established separately for each folder FL, and any folder FL may be used as a shared folder.

The user information database 104 stores a terminal device information table TL1 that indicates the relationship between each user and the terminal device 2 as shown in FIG. 4, as well as a folder information table TL2 that indicates the relationship between each user and the folder FL, as shown in FIG. 5.

The terminal device information table TL1 shown in FIG. 4 associates for each user and stores a user name 41, terminal identification information 42 and an access flag 4F. The terminal identification information 42 is information that identifies the terminal device 2 for that user. For this terminal identification information 42, an address (such as an IP address, for example) assigned for the terminal device 2 may be used. Alternatively, the computer name, MAC address or telephone number assigned to the terminal device 2 may be used.

The access flag 4F indicates whether or not that user's terminal device 2 is in a state in which it can connect to (access) the multifunction apparatus 1 at that moment. ‘1’ indicates that the terminal device 2 is in an accessible state, while ‘0’ indicates that it is not in an accessible state. For example, if the terminal device 2 responds to a polling signal, broadcast signal, ping or the like issued from the multifunction apparatus 1, the access flag 4F indicates ‘1’. If the terminal device 2 is powered off, or if the terminal device 2 network function is not working, the access flag 4F indicates ‘0’.

The folder information table TL2 shown in FIG. 5 associates with each folder FL and stores a folder name 51, a user name 52 for the user who is the owner of that folder FL, and access permission information SR. The access permission information SR indicates the users permitted to access that folder FL.

Returning to FIG. 3, the access state determination unit 101 issues an inquiry to each terminal device 2, and determines based on the result of these inquiries whether or not each terminal device 2 is in a state in which it can connect to (access) the multifunction apparatus 1.

For example, the access state determination unit 101 issues a broadcast, and determines that the terminal devices 2 corresponding to the addresses collected through this broadcast are in a state in which they can access the multifunction apparatus 1. At the same time, it is determined that the terminal devices 2 having an assigned address (see FIG. 4) that is not included in the collected addresses are not in a state in which they can access the multifunction apparatus 1.

Alternatively, the terminal devices 2 are polled, and the access state determination unit 101 determines that the terminal devices 2 that responded to the polling signal are in a state in which they can access the multifunction apparatus 1. At the same time, it is determined that the terminal devices 2 that did not respond to the polling signal are not in a state in which they can access the multifunction apparatus 1. It is also acceptable if the access state determination unit 101 sends a ping request to each terminal device 2, and determines that the terminal devices 2 that responded to the ping request are in a state in which they can access the multifunction apparatus 1.

These determinations are performed periodically. Where there is a change regarding terminal devices 2 that can access the multifunction apparatus 1, the contents of the terminal device information table TL1 shown in FIG. 4 are updated to reflect this change.

Where a broadcast signal is issued from a terminal device 2 that has been powered on or has attained network functioning, the access state determination unit 101 determines that the terminal device 2 has entered the state in which it can access the multifunction apparatus 1, and updates the contents of the terminal device information table TL1 accordingly.

When a terminal device 2 accesses the user data storage area 105, the folder notification unit 102 generates folder information 70 that indicates the folder names of the folders FL located in the user data storage area 105, and sends this information to the terminal device 2. This causes the list view screen HGL that displays a list of access-enabled folders FL on the terminal device 2, as shown in FIG. 6.

The folder information 70 is generated based on the access permission information 5R (see FIG. 5) that is set for each user's folder FL and the access flag 4F (see FIG. 4) for the user's terminal device 2. Specifically, folder information 70 is generated such that (i) the folder names for the folders FL that satisfy both of the following conditions (1) and (2) are included, and (ii) the folder names for the folders FL that do not satisfy either of the conditions (1) and (2) are not included.

(1) The terminal device 2 of the user who owns the folder FL is determined to be in a state in which it can access the multifunction apparatus 1. In other words, the folder owner's access flag 4F is ‘1’.

(2) Permission to access the folder FL has been given to the user of the terminal device 2 that accessed the user data storage area 105.

For example, in the situation shown in FIGS. 4 and 5, because the user B has not been given permission to access the folder FLC, the condition (2) regarding the folder FLC is not satisfied for the user B. Furthermore, because the terminal device 2 of the user A is not in a state in which it can access the multifunction apparatus 1, the condition (1) is not satisfied with regard to the folder FLA. Both conditions are satisfied for the folders FLB, FLD and FLE. Therefore, where the user B's terminal device 2 has accessed the user data storage area 105, folder information 70 to display the list view screen HGL 1 shown in FIG. 6(a) is generated and is sent to that terminal device 2.

If the user B has been permitted to access all of the folders FLA through FLE, and the access flags 4F for the terminal devices 2 for the users A through E are all ‘1’, folder information 70 to display the list view screen HGL2 shown in FIG. 6(b) is generated.

By specifying a folder FL by mouse-clicking on its icon displayed in the list view screen HGL, the user can issue to the multifunction apparatus 1 a request for access to that folder FL. Alternatively, access can be requested by entering the path of the folder FL, the folder name, the URL or other identifying information in the command input screen (prompt screen) using the keyboard.

Returning to FIG. 3, the access management unit 103 receives a request to access a folder FL from a terminal device 2 and determines whether or not the terminal device 2 should be permitted to access the folder FL. If it determines that access should be permitted, the access management unit 103 gives the terminal device 2 permission to access the folder FL and the files stored therein. Otherwise, access is denied.

This determination is made based on the conditions (1) and (2) described above. If both conditions are met, it is determined that the folder FL may be accessed. If either of the conditions is not met, access is denied. In other words, access is granted only to the folders FL displayed in the list view screen HGL.

Therefore, even if the folder name, path or URL of a folder FL that is not displayed in the list view screen HGL is specified directly via the command input screen, access will be denied unless both of the conditions (1) and (2) above are met. However, if there is a change in the state or access permission settings for the terminal device 2 belonging to the user who owns the folder FL during the period between display of the list view screen HGL and the issuance of the access request, the result of the access permission determination may vary.

The folder contents screen HGF that displays a list of files stored in the folder FL is displayed on the terminal device 2 that was given permission to access that folder FL, as shown in FIG. 7. The user of the terminal device 2 can use these files for his own work.

For example, the user may select and download to the terminal device 2 a document file to be used for future work (such as a text file, image file or document file created in a word processor). The file can then be opened using the application software installed on the terminal device 2 that corresponds to its file type.

Alternatively, the user may select an executable file for the application software that is used for sending documents and is installed on the multifunction apparatus 1, and can run the application software on the multifunction apparatus 1. The user may then issue a command to the multifunction apparatus 1 to send the document or other file specified by the user to another device 4 (see FIG. 1).

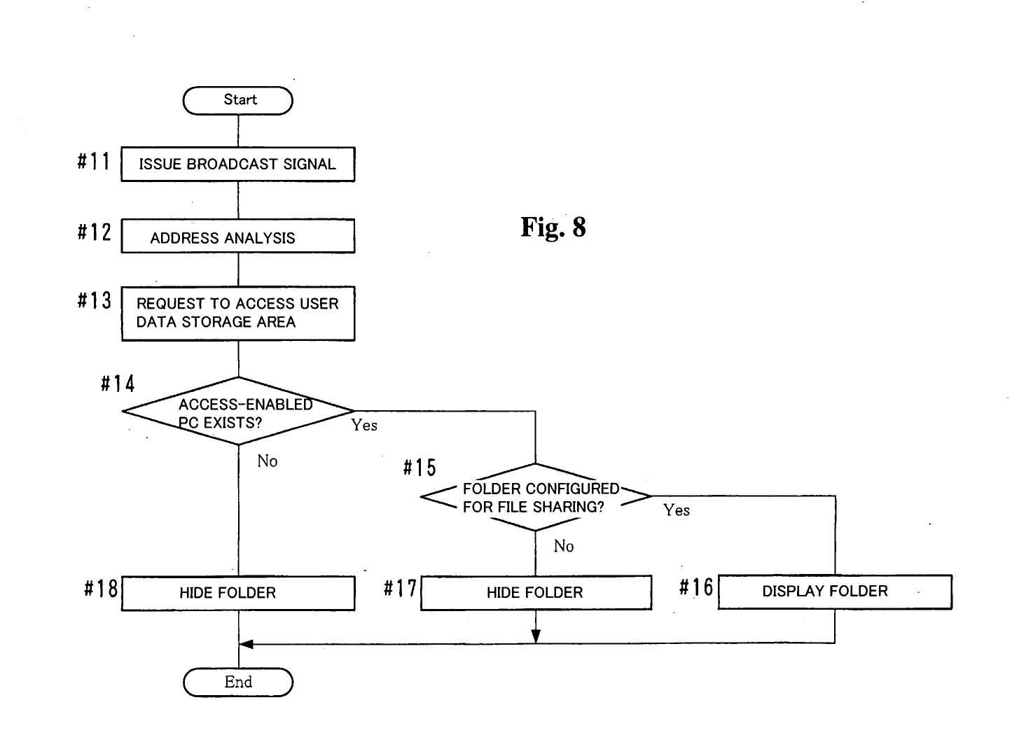

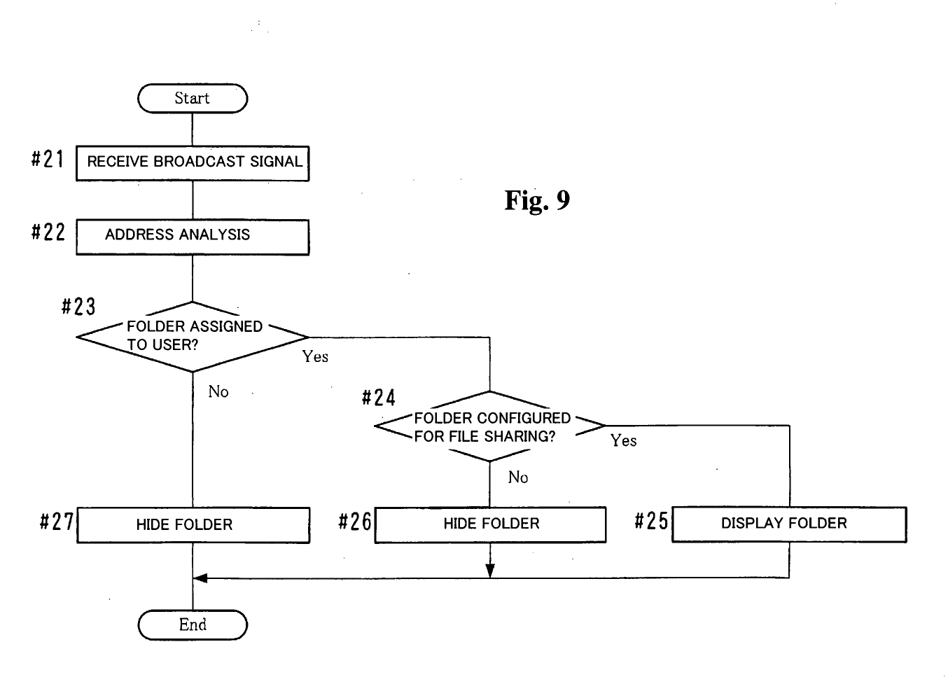

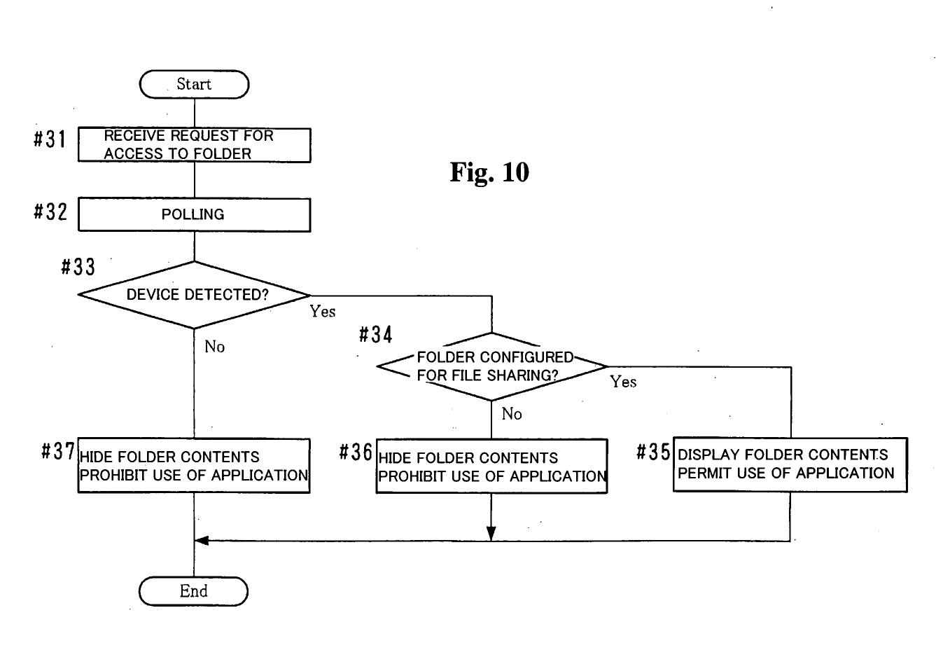

FIG. 8 is a flow chart that explains an example of the processing sequence by which it is determined whether or not the folder name of another user's folder FL will be displayed, FIG. 9 is a flow chart that explains an example of the processing sequence by which it is determined whether or not the folder name of the user's own folder FL will be displayed, and FIG. 10 is a flow chart that explains an example of the processing sequence pertaining to file management performed when a folder FL is accessed.

The various processes shown in FIGS. 8-10 are executed by running the programs stored in the ROM 1c or the like using the CPU1a.

The sequence of operations pertaining to management of the folders FL on the multifunction apparatus 1 will now be explained with reference to the flow chart.

As shown in FIG. 8, the multifunction apparatus 1 broadcasts periodically, issuing broadcast signals over the communication lines 3 (#11). By analyzing the addresses of the devices responding to the signal, the multifunction apparatus 1 determines which of the terminal devices 2 are in a state in which they can access the multifunction apparatus 1 and which are not in such a state (#12). Alternatively, the terminal devices that are in an access-enabled state can be determined by polling the addresses displayed in the terminal identification information 42 for each user's terminal device 2 (see FIG. 4), rather than by broadcasting.

If a request to access the user data storage area 105 (see FIG. 3) in the multifunction apparatus 1 is issued from a user's terminal device 2 (#13), the folder names of other users' folders FL that should be displayed in the list view screen HGL (see FIG. 6) are determined using the method described below.

Where the terminal devices 2 of these other users are in an access-enabled state, and the folders FL of these users are configured for file sharing (i.e., access permission is granted to the requesting user) (YES in #14, YES in #15), the folder names of the folders FL of these other users are determined to be displayed in the list view screen HGL (#16). If access permission has not been given to the requesting user regarding any other user (NO in #15), it is determined that the folder name of the folder FL for such other user will not be displayed in the list view screen HGL, even if the terminal device 2 of the other user is in an access-enabled state (#17).

If the terminal device 2 of any other user is not in a state in which it can access the multifunction apparatus 1 (NO in #14), it is determined that the folder name of the folder FL belonging to such other user will not be displayed in the list view screen HGL, even if the folder FL belonging to such other user is configured for file sharing (#18).

At the same time, whether or not the folder name of the folder FL of the user requesting access in step #13 will be displayed in the list view screen HGL is determined in the manner described below.

Prior to an access request, the terminal device 2 of the requesting user is powered on and enters the state in which it can access the multifunction apparatus 1. At the moment it enters the access-enabled state, the terminal device 2 issues a broadcast.

When the broadcast is issued, the multifunction apparatus 1 receives the broadcast signal as shown in FIG. 9 (#21). It then recognizes from analysis of the associated address that the user's terminal device 2 has entered a state in which it can access the multifunction apparatus 1 (#22).

When in this state, if a request to access the user data storage area 105 is received from the terminal device 2 for that user (corresponding to #13 in FIG. 8), the multifunction apparatus 1 checks whether or not a folder FL has been assigned to the user. If a folder FL has been assigned, the multifunction apparatus 1 further checks whether or not the folder FL has been configured for file sharing (i.e., whether or not access permission has been granted).

If a folder FL has been assigned to the user and has been configured for file sharing (YES in #23, YES in #24), it is determined that the folder name of the user's folder FL will be displayed in the list view screen HGL (#25). If not (NO in #23 or NO in #24), it is determined that the folder name of that user's folder FL will not be displayed in the list view screen HGL (#26 or #27).

As a result of the operations shown in FIGS. 8 and 9, the folder information 70 is sent to the requesting user's terminal device 2 and the list view screen HGL shown in FIG. 6 is displayed. The user can access a folder FL by clicking on the icon of the folder FL in the list view screen HGL.

When this is done, the multifunction apparatus 1 manages the files stored in the folder FL in accordance with the following sequence of operations.

As shown in FIG. 10, when a request for notification of the list of files stored in a folder FL or a request for access to any of such files is received (#31), the multifunction apparatus 1 polls the terminal device 2 of the user who owns that folder FL (#32).

Where a response to the polling signal has been received, i.e., where the terminal device 2 belonging to the user who owns the folder FL is detected, and that user's folder FL has been configured for file sharing (YES in #33, YES in #34), the terminal device 2 belonging to the requesting user is notified of the contents of the folder FL, i.e., of a list of the files stored therein (#35). As a result, the folder contents screen HGF shown in FIG. 7 is displayed on the terminal device 2 of the requesting user. Alternatively, where an executable file for application software stored in the folder FL is specified, the executable file is booted on the multifunction apparatus 1 to run the application.

Where there is no response to the polling signal, i.e., where the terminal device 2 belonging to the owner of the folder FL is not detected (NO in #33), it is determined that the terminal device 2 is not currently in a state in which it can access the multifunction apparatus 1. Therefore, the requesting user's terminal device 2 is not notified of the contents of the folder FL (#37). In addition, where an executable file constituting part of application software stored in the folder FL is specified, use of that application software is denied.

If the folder FL is not configured for file sharing (NO in #34), the requesting user's terminal device 2 is not notified of the contents of the folder FL, and use of the application software is also denied (#36).

According to this embodiment, when a user is not working, access to the user's folder FL can be denied. In other words, in the conventional art, so long as the server is running, the folder FL is always available to other users regardless of the state of the terminal device 2 belonging to the user owning such folder FL. According to this embodiment, however, access to the folder FL can be managed in accordance with the state of the user's terminal device 2. Therefore, other users are prevented from using the user's folder FL without the user's knowledge, giving the user a sense of security.

Furthermore, the folder FL can be used as a virtual hard disk (local disk) for the terminal device 2. In addition, if the network function of the terminal device 2 is off-line, the folder FL is not visible to other terminal devices, as described above. Therefore, even a device lacking a hard disk or other high-capacity storage means, such as a PDA, may be used as if it were a server in a peer-to-peer network

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

In this embodiment, the determination of whether or not the terminal device 2 belonging to the user who owns the folder FL is in a state in which it can connect to (access) the multifunction apparatus 1 is made via broadcast or polling, but such determination may be made using a different method.

For example, a construction may be adopted in which the multifunction apparatus 1 is associated with an account for each user, who must log into the multifunction apparatus 1 in order to use the documents stored therein. In this case, during the period from the user's successful login to the user's eventual logoff, it is determined that the user's terminal device 2 is in an access-enabled state. On the other hand, where the user is not logged in, it is determined that the user's terminal device 2 is not in an access-enabled state.

In this embodiment, the determination of whether or not the terminal devices 2 are in an access-enabled state is made periodically, but the timing of this determination is not limited to this implementation. For example, it is acceptable if the determination of whether or not the terminal device 2 of the user who owns a folder FL is in an access-enabled state is made each time another terminal device 2 accesses that folder FL.

This embodiment was described using an example in which folder sharing was managed using a multifunction apparatus (MFP) having a document server function, but a so-called UNIX® server or PC server may be used instead of a multifunction apparatus.

The present invention may be applied in a network system used by members of a company, school or government organization (such as a company LAN). Alternatively, it may be applied in the network system of an ISP (Internet Service Provider) that provides terminal devices in individual homes with Internet access-related services.

Furthermore, the construction of all or part of the file sharing system 100 and multifunction apparatus 1, as well as the contents of processing, the sequence of processing, and the method of determination regarding the state of the terminal devices 2, may be changed freely within the essential scope of the present invention.

1. A data management server that manages data that can be used by multiple terminal devices, comprising:
a storage device in which separate storage areas are allocated for each user;
a determination unit that determines which of the terminal devices is in a state in which it is able to access the data management server; and
an access management unit that, when a terminal device issues a request to access a separate storage area of the storage device, if it is determined by the determination unit that the terminal device being used by a user associated with the separate storage area is in a state in which it can access the data management server, permits the terminal device that requested to access the data stored in the separate storage area, while if the terminal device is not in such a state, denies access to the data stored in the separate storage area.

2. The data management server of claim 1, further comprising an identification information notification unit that issues, to the terminal device that has requested access to the data management server, identification information that identifies separate storage areas regarding, from among all users to whom separate storage areas are allocated, only those users who are using a terminal device determined by the determination unit to be in a state in which it can access the data management server.

3. The data management server of claim 2, wherein the determination unit makes said determination at prescribed intervals, the identification information notification unit determines, based on the results of the most recent determination, the users regarding whom the identification information will be given, and the access management unit determines whether or not to permit access based on the results of the most recent determination by the determination unit.

4. The data management server of claim 1, wherein said data comprises an executable file of application software for performing processing that is to be executed on the data management server, and when a terminal device requests that the executable file be run, the access management unit permits the executable file to be run where it is determined by the determination unit that the terminal device being used by the user associated with the separate storage area in which the executable file is stored is in a state in which it can access the data management server, but does not permit the executable file to be run where it is determined that the terminal device is not in such a state.

5. A data management method that manages a storage unit in which separate storage areas are allocated for each user, said method comprising the steps of:
when a request to access a separate storage area of the storage unit is received from a terminal device, determining whether or not the terminal device being used by the user associated with the separate storage area is in a state in which it can access the storage unit; and
when it is determined that the terminal device is in such the state in which it can access the storage unit, permitting the terminal device that requested to access the data stored in the separate storage area, but denying access when the terminal device is not in such a state.

6. A computer program that is run on a computer having a storage unit in which separate storage areas are allocated to each user, such computer program executing on the computer the processes of:
determining terminal devices that are in a state in which they can access the computer; and
when a request to access a separate storage area of the storage unit is received from a terminal device, and it is determined that the terminal device being used by the user associated with the separate storage area is in a state in which it can access the computer, permitting the terminal device that requested to access the data stored in the separate storage area, but denying access where the terminal device is not in such a state.
